(19) United States
(12) Patent Application Publication
(10) Pub. No.: US 2026/0161495 A1
(43) Pub. Date: Jun. 11, 2026

(54) IDENTIFYING ENVIRONMENTAL CONDITIONS OF HARDWARE ERRORS

(71) Applicant: Advanced Micro Devices, Inc., Santa Clara, CA (US)

(72) Inventors: Kun Tan, Shanghai (CN); Atul Subhash Athavale, Sunnyvale, CA (US); Vilas Sridharan, Boston, MA (US); Jeffrey Richard Rearick, Fort Collins, CO (US)

(21) Appl. No.: 18/973,766

(22) Filed: Dec. 9, 2024

(51) Int. Cl. G06F 11/07

(52) U.S. Cl. CPC G06F 11/0787

(57) ABSTRACT

An apparatus and method for efficiently performing error reporting of an integrated circuit. In various implementations, a computing system includes multiple functional blocks used to process one or more applications. The functional blocks are components of an integrated circuit such as a processing circuit, a processor core, a particular level of a cache memory hierarchy, a memory controller that interfaces with one or more memory devices, an input/output controller that interfaces with a peripheral device, a network interface, and so on. A combination of sensors, hardware performance counters, and control circuits monitor environmental conditions of the multiple functional blocks. When an error occurs or a time interval has elapsed, an error reporting circuit retrieves and stores parameters characterizing the environmental conditions. This information can be used at a later time for error debugging, searching for a minimum power supply voltage, and other transient state data processing.

### BACKGROUND

### Description of the Relevant Art

When transferring information between functional blocks in semiconductor chips, electrical signals are sent on multiple, parallel metal traces. These metal traces have transmission line effects such as distributed inductance, capacitance, and resistance throughout the lengths of these metal traces. For modern integrated circuits, the constantly decreasing widths of transistors and metal traces reduces signal integrity. In addition, as the operating voltage continues to decrease to reduce power consumption, the signal swing used for Boolean logic decreases as well as the noise margin. Therefore, the bit error rate in a computing system increases as the complexity increases and the manufacturing processes continue to advance.

To improve reliability and reduce down time, error handling techniques are provided by the hardware. However, as the complexity of the computing system increases, the number of hardware topologies made available by separate components, such as the motherboard and cards providing access to peripheral devices, also increases. Typically, when hardware detects the occurrence of an error, the hardware stores the type of error and the location of the error in the computing system in a designated storage location. Later, however, during analysis of the device under test (DUT) or the unit under test (UUT) in a controlled lab environment, determining the cause of the error in order to identify a solution consumes a vast amount of time and resources. Setting up the test system with the same environmental conditions and applying the appropriate test cases can be time consuming. Such a process often takes days.

In view of the above, methods and apparatuses for efficiently performing error reporting of an integrated circuit are desired.

### BRIEF DESCRIPTION OF THE DRAWINGS

FIG. 1 is a generalized diagram of a computing system that efficiently performs error reporting of an integrated circuit.

FIG. 2 is a generalized diagram of an apparatus that efficiently performs error reporting of an integrated circuit.

FIG. 3 is a generalized diagram of a computing system that efficiently performs error reporting of an integrated circuit.

FIG. 4 is a generalized diagram of a method for efficiently performing error reporting of an integrated circuit.

FIG. 5 is a generalized diagram of a method for efficiently performing error reporting of an integrated circuit.

FIG. 6 is a generalized diagram of a method for efficiently performing error reporting of an integrated circuit.

While the invention is susceptible to various modifications and alternative forms, specific implementations are shown by way of example in the drawings and are herein described in detail. It should be understood, however, that drawings and detailed description thereto are not intended to limit the invention to the particular form disclosed, but on the contrary, the invention is to cover all modifications, equivalents and alternatives falling within the scope of the present invention as defined by the appended claims.

### DETAILED DESCRIPTION

In the following description, numerous specific details are set forth to provide a thorough understanding of the present invention. However, one having ordinary skill in the art should recognize that the invention might be practiced without these specific details. In some instances, well-known circuits, structures, and techniques have not been shown in detail to avoid obscuring the present invention. Further, it will be appreciated that for simplicity and clarity of illustration, elements shown in the figures have not necessarily been drawn to scale. For example, the dimensions of some of the elements are exaggerated relative to other elements.

Apparatuses and methods for efficiently performing error reporting of an integrated circuit are disclosed. In various implementations, a computing system includes multiple functional blocks used to process one or more applications. In various implementations, the one or more functional blocks are components of an integrated circuit such as a processing circuit, a processor core, a particular level of a cache memory hierarchy, a memory controller that interfaces with one or more memory devices, an input/output controller that interfaces with a peripheral device, a network interface, and so on. A combination of sensors, hardware performance counters, and control circuits monitor environmental conditions of the multiple functional blocks. Examples of the environmental conditions are the operational power supply voltage, the operational clock frequency, the operational temperature, a measured amount of current draw by the one or more functional blocks, a measured amount of electromagnetic interference (EMI), a measured amount of ambient temperature, a measured amount of ambient humidity, a monitored switching activity of one or more buses, and so on.

When there is an occurrence of an error, an error reporting circuit generates an indication of the error type. Examples of the error types are translation lookaside buffer (TLB) errors, system bus errors, random access memory (RAM) storage errors, bit flipping errors, and so forth. The error reporting circuit stores, in an error register such as a control register or machine check architecture (MCA) register, the indication of the error type, a timestamp, and a location of the error occurrence. The error reporting circuit also stores the parameters characterizing the environmental conditions and the timestamp in an error buffer. The error buffer is a separate data structure from a data structure used for the error register (control register). Through the timestamp, a link is created between the information stored in the error buffer and the information stored in the error register. The parameters characterizing the environmental conditions can be used during later debugging and analysis to reduce the time to find the cause of the error.

Typically, computing devices only store the indication of the error type, a timestamp, and a location of the error occurrence in the error register such as the MCA register. However, this information can be limited and cause later analysis of the device under test (DUT) or the unit under test (UUT) in a controlled lab environment to take days to find the cause of the error in order to identify a solution. However, with the error reporting circuit also using the error buffer, more information can be obtained to shorten the analysis. The error buffer is a separate data structure from a data structure used for the error register. Typically, the error buffer has more data storage capacity than the error register. Rather than using firmware or any other type of software to generate the timestamp, the error reporting circuit relies on the output clock signal of the hardware of the clock generating circuitry to generate the timestamp. The error reporting circuit stores, in the error register, such as the MCA register, this timestamp along with the indication of the error type and location of the error occurrence.

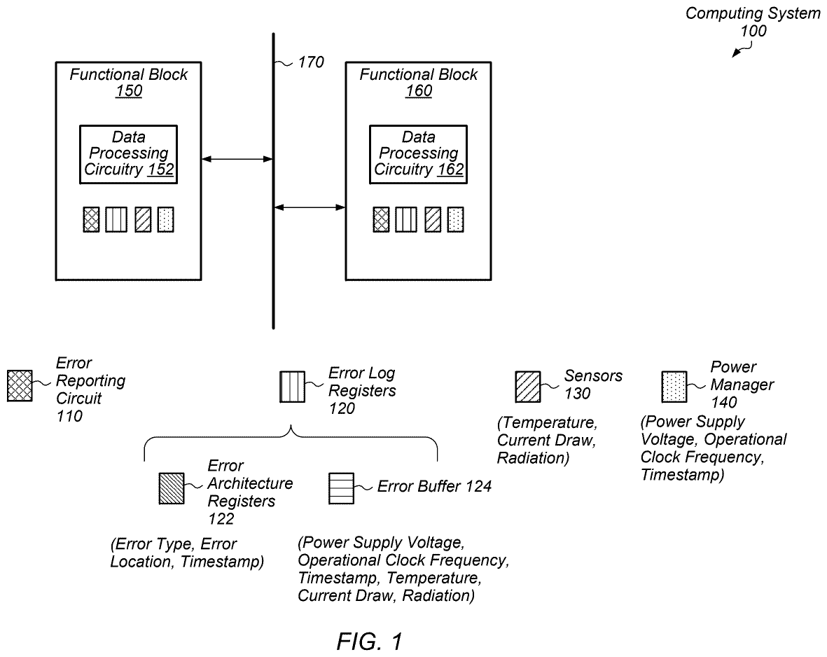

The error reporting circuit retrieves parameters characterizing the environmental conditions from the sensors, hardware performance counters, and hardware monitors. The error reporting circuit stores the parameters and the timestamp in the error buffer. In some implementations, the error reporting circuit also retrieves and stores these parameters when a time interval has elapsed to build a history of the environmental conditions. In various implementations, at a later time, one or more of a processing circuit, diagnostic lab equipment, and so forth utilizes the history of information for error debugging, searching for a minimum supported power supply voltage, and other transient state data processing. Regarding searching for a minimum power supply voltage, the output voltage from a device (transistor) reduces as it drives a load. When driving a lot of current, even when utilizing a path with a low amount of resistance, the output voltage can experience voltage droop. Additionally, a simultaneous switching of a wide bus can cause a significant voltage drop if a supply pin served all of the line buffers on the bus. Parasitic inductance increases transmission line effects on an integrated circuit such as ringing and reduced propagation delays. The voltage regulator circuit needs to be designed to account for voltage droop. The recorded history of environmental conditions can improve the search for the minimum supported power supply voltage, the error debugging process, and other processing. Further details of these techniques for efficiently performing error reporting of an integrated circuit are provided in the following description of FIGS. 1-6.

Turning now to FIG. 1, a generalized diagram is shown of a computing system 100 that efficiently performs error reporting of an integrated circuit. In the illustrated implementation, computing system 100 includes at least functional block 150, functional block 160, and interconnect 170. In other implementations, computing system 100 includes other components and/or computing system 100 is arranged differently. For example, power management circuitry, and phased locked loops (PLLs) or other clock generating circuitry are not shown for ease of illustration. In various implementations, the components of the computing system 100 are on the same die such as a system-on-a-chip (SOC). In other implementations, the components are individual dies in a system-in-package (SiP) or a multi-chip module (MCM). A variety of computing devices use the computing system 100 such as a desktop computer, a laptop computer, a server computer, a tablet computer, a smartphone, a gaming device, a smartwatch, and so on.

Functional blocks 150 and 160 are representative of any number of functional blocks included in computing system 100. Functional blocks 150 and 160 can be components of an integrated circuit such as a processing circuit, a processor core, a particular level of a cache memory hierarchy, a memory controller that interfaces with one or more memory devices, an input/output controller that interfaces with a peripheral device, a network interface, and so on. Functional block 150 includes data processing circuitry 152, which processes data based on the functionality provided by functional block 150. For example, data processing circuitry 152 can include circuitry for arithmetic logic units (ALUs) that perform integer arithmetic, floating-point arithmetic, Boolean logic operations, branch condition comparisons, and so forth. Data processing circuitry 152 can include circuitry of pipeline stages of general-purpose processor cores and the corresponding intermediate pipeline registers. Data processing circuitry 152 can include circuitry of data storage memory cells such as random-access memory (RAM) cells of a cache array, or data processing circuitry 152 can include circuitry of the cache controller and/or the tag array. Data processing circuitry 152 can include metal traces of data transmission lanes and corresponding transmitter and receiver circuitry. Data processing circuitry 152 can include a variety of other examples of data processing circuitry. Similarly, data processing circuitry 162 can include these examples of data processing circuitry.

Due to the variety of types of circuitry that can be in data processing circuitry 152 and 162, functional blocks 150 and 160 can process a variety of types of tasks. The variety of types of tasks support the processing of instructions of algorithms implemented in applications, firmware and so on. These tasks can include a variety of types of computing operations such as arithmetic operations, memory access operations, data transmission operations, and so forth. In some implementations, the interconnect 170 is a bus, whereas in other implementations, interconnect 170 is a communication fabric (or fabric). Whether interconnect 170 is a bus or a fabric, interconnect 170 includes circuitry for supporting communication, data transmission, network protocols, address formats, interface signals and synchronous/asynchronous clock domain usage for routing data. Computing system 100 also includes error reporting circuit 110, error log registers 120, sensors 130 and power managers 140. As shown, these components 110, 120, 130 and 140 have multiple replicated copies distributed across computing system 100. The multiple instantiations of components 110, 120, 130 and 140 monitor environmental conditions of multiple different locations across computing system 100. When an error occurs or a time interval has elapsed, parameters characterizing the environmental conditions are retrieved and stored. This information can be stored over time to generate history information. This history information can be used later for error debugging, searching for a minimum power supply voltage, and other transient state data processing.

In various implementations, at a later time, one or more of a processing circuit, diagnostic lab equipment, and so forth utilizes the history of information for error debugging, searching for a minimum supported power supply voltage, and other transient state data processing. Regarding searching for a minimum power supply voltage, the output voltage from a device (transistor) reduces as it drives a load. When driving a lot of current, even when utilizing a path with a low amount of resistance, the output voltage can experience voltage droop. Additionally, a simultaneous switching of a wide bus can cause a significant voltage drop if a supply pin served all of the line buffers on the bus. Parasitic inductance increases transmission line effects on an integrated circuit such as ringing and reduced propagation delays. The voltage regulator circuit needs to be designed to account for voltage droop. The recorded history of environmental conditions can improve the search for the minimum supported power supply voltage, the error debugging process, and other processing.

Examples of the environmental conditions are the operational power supply voltage, the operational clock frequency, the operational temperature, a measured amount of current draw by the one or more functional blocks, a measured amount of electromagnetic interference (EMI), a measured amount of ambient temperature, a measured amount of ambient humidity, a monitored switching activity of one or more buses, and so on. Sensors 130 include one or more of an on-die temperature sensor, an on-die current draw sensor, and an on-die electromagnetic sensor that measures electromagnetic interference (EMI). These parameters characterizing environmental conditions can also be referred to as “telemetry data.” It is possible and contemplated that additional sensors are also used such as an off-die temperature sensor that measures ambient temperature such as room temperature or outdoor temperature surrounding the computing device that uses functional blocks 150 and 160. The additional sensors can also include an off-die sensor that measures ambient humidity such as room humidity or outdoor humidity surrounding the computing device that uses functional blocks 150 and 160. The additional sensors can also include one of a variety of off-die gyroscopes for measuring orientation and angular velocity of the computing device that uses functional blocks 150 and 160. The information provided by sensors 130 can be reported to error reporting circuit 110 when requested.

Power manager 140 includes power management circuitry that selects an operational power supply voltage and operational clock frequency for functional blocks 150 and 160. This information can be reported to error reporting circuit 110 when requested. Power manager 140 selects the operational power supply voltage and operational clock frequency based on dynamic performance requirements and power consumption requirements of computing system 100. In an implementation, power manager 140 includes a voltage regulator or can access a voltage regulator. Additionally, in an implementation, power manager 140 includes the on-die current sensor that measures the amount of current drawn by one or more power supply rails used by the one or more of functional blocks 150 and 160.

Error log registers 120 includes error architecture registers 122 and error buffer 124. In an implementation, error architecture registers 122 include machine check architecture (MCA) registers. The functional blocks 150 and 160 perform error management based on the machine check architecture. The machine check architecture defines the steps and techniques used by functional blocks 150 and 160 for detecting, reporting, and handling errors that occur in computing system 100. Typically, an allocated register of error architecture registers 122 stores an indication of an error type and an indication of a location of the error. Error architecture registers 122 can also store a timestamp and a pointer to a corresponding buffer entry of error buffer 124. This buffer entry specified by the pointer stores parameters of the environmental conditions as they existed at the time of the error occurrence. The pointer is an address or other information (e.g., offset, mapping, other) identifying a data storage location. Examples of the environmental conditions were provided earlier. When there is an occurrence of an error or a time interval has elapsed, error reporting circuit 110 sends requests to retrieve parameters characterizing the environmental conditions of a corresponding one of the functional blocks 150 and 160. Error reporting circuit 110 stores the retrieved parameters in the error log registers 120. In addition, error reporting circuit 110 sends an indication of an interrupt to a processing circuit.

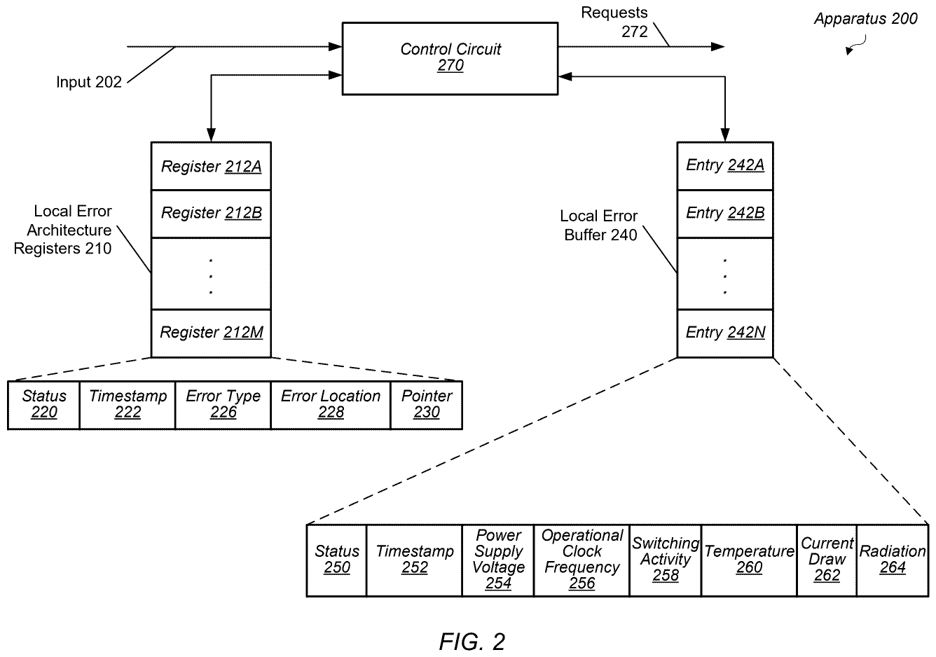

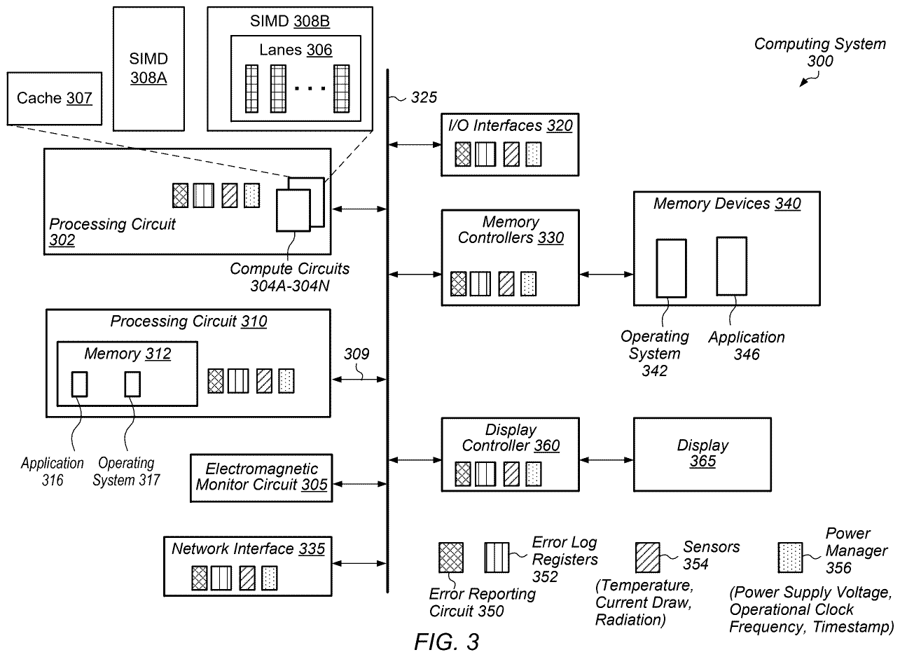

Turning now to FIG. 2, a generalized diagram is shown of an apparatus 200 that efficiently performs error reporting of an integrated circuit. In various implementations, apparatus 200 includes the functionality of error reporting circuit 110 (of FIG. 1) and error reporting circuit 350 (of FIG. 3). As shown, apparatus 200 includes control circuit 270, local error architecture registers 210 and local error buffer 240. Control circuit 270 receives input 202, accesses local error architecture registers 210 (or registers 210) and local error buffer 240 (buffer 240), and generates requests 272. Input 202 includes an indication of an error and an indication specifying whether a time interval has elapsed. In another implementation, control circuit 270 includes a timer that measures time duration and compares the measured time duration to a threshold that indicates the time interval. In an implementation, control circuit 270 includes configuration and status registers (CSRs) that can store a programmable threshold. In another implementation, control circuit 270 accesses one or more of a timer and configuration registers to determine whether the time interval has elapsed.

When input 202 indicates there is an occurrence of an error or the time interval has elapsed (or control circuit 270 determines the time interval has elapsed), control circuit 270 sends requests 272 to retrieve parameters characterizing the environmental conditions of a corresponding functional block. Examples of the environmental conditions are the operational power supply voltage, the operational clock frequency, the operational temperature, a measured amount of current draw by the one or more functional blocks, a measured amount of electromagnetic interference (EMI), a measured amount of ambient temperature, a measured amount of ambient humidity, a monitored switching activity of one or more buses, and so on. Control circuit 270 sends the requests 272 to one or more of a power manager and data storage elements storing information provided by a variety of types of sensors. Examples of the sensors are the types of sensors used in sensors 130 (of FIG. 1). Input 202 also provides the requested information to control circuit 270.

Local error architecture registers 210 (or registers 210) includes multiple registers (or entries), such as registers 212A-212M, each storing information in multiple fields such as at least fields 220-230. Registers 210 are implemented by a data structure that utilizes one of flip-flop circuits, a random-access memory (RAM), a content addressable memory (CAM), or other. Although particular information is shown as being stored in the fields 220-230 and in a particular contiguous order, in other implementations, a different order is used, and a different number and type of information is stored. As shown, field 220 stores status information such as at least a valid bit indicating valid information is stored in an allocated register.

Field 222 stores a timestamp. In various implementations, control circuit 270 generates a timestamp based on a local operational clock signal. Rather than using firmware or any other type of software to generate the timestamp, control circuit 270 relies on the output clock signal of the hardware of the clock generating circuitry. In this manner, the point in time that the parameters characterizing environmental conditions are stored with respect to the elapsed time interval are related to the point in time these parameters are stored with respect to an error occurrence.

Field 226 stores an indication of the error type. Examples of the error types are translation lookaside buffer (TLB) errors, system bus errors, random access memory (RAM) storage errors, bit flipping errors, and so forth. Field 228 stores an indication of an error location. This indication can be an identifier (ID) of the corresponding one of the functional blocks 150 and 160. Field 230 stores a pointer identifying one of the entries 242A-242N of local error buffer 240 (buffer 240). This entry specified by the pointer in field 230 stores parameters of the environmental conditions as they existed at the time of the error occurrence. The pointer is an address or other information (e.g., offset, mapping, other) identifying a data storage location.

Buffer 240 is a separate data structure from registers 210. In various implementations, each of the entries 242A-242N has more data storage capacity than any register of registers 212A-212M. Similar to registers 210, buffer 240 is a data structure that utilizes one of flip-flop circuits, a random-access memory (RAM), a content addressable memory (CAM), or other. Although particular information is shown as being stored in the fields 250-264 and in a particular contiguous order, in other implementations, a different order is used, and a different number and type of information is stored. As shown, field 250 stores status information such as at least a valid bit indicating valid information is stored in an allocated entry.

Field 252 stores a timestamp generated by control circuit 270. Field 254 stores the currently used operational power supply voltage, and field 256 stores the currently used operational clock frequency for the corresponding functional block. Field 258 stores an indication of switching activities of one or more buses of the corresponding functional block. Control circuit 270 can access hardware performance counters that monitor a ratio of data transmission lines of a bus that switch over time. Field 260 stores an indication of the operational temperature measured by a temperature sensor. Field 262 stores an indication of the amount of current drawn measured by an on-die current sensors. Field 264 stores an indication of electromagnetic interference (EMI) measured by an on-die electromagnetic monitor. Other types of parameters indicating environmental conditions that can be stored in entries 242A-242N are possible and contemplated. In some implementations, control circuit 270 migrates information stored in registers 210 and buffer 240 to memory mapped input/output (MMIO) storage locations, or MMIO registers. Therefore, over time, this information is stored in system memory without being overwritten while also allowing data storage locations to be de-allocated (freed) in registers 210 and buffer 240.

Turning now to FIG. 3, a generalized diagram is shown of a computing system 300 that efficiently performs error reporting of an integrated circuit. In various implementations, computing system 300 includes at least processing circuits 302 and 310, input/output (I/O) interfaces 320, bus 325, network interface 335, memory controllers 330, memory devices 340, display controller 360, and display 365. In other implementations, computing system 300 includes other components and/or computing system 300 is arranged differently. For example, power management circuitry, and phased locked loops (PLLs) or other clock generating circuitry are not shown for ease of illustration. In various implementations, the components of the computing system 300 are on the same die such as a system-on-a-chip (SOC). In other implementations, the components are individual dies in a system-in-package (SiP) or a multi-chip module (MCM). A variety of computing devices use the computing system 300 such as a desktop computer, a laptop computer, a server computer, a tablet computer, a smartphone, a gaming device, a smartwatch, and so on.

Processing circuits 302 and 310 are representative of any number of processing circuits which are included in computing system 300. In an implementation, processing circuit 310 is a general-purpose central processing unit (CPU). In one implementation, processing circuit 302 is a parallel data processing circuit with a highly parallel data microarchitecture, such as a GPU. The processing circuit 302 can be a discrete device, such as a dedicated GPU (dGPU), or the processing circuit 302 can be an integrated (an iGPU) in the same package as another processing circuit. Other parallel data processing circuits that can be included in computing system 300 include digital signal processing circuits (DSPs), field programmable gate arrays (FPGAs), application specific integrated circuits (ASICs), and so forth.

In various implementations, the processing circuit 302 includes multiple, replicated compute circuits 304A-304N, each including similar circuitry and components such as a single instruction multiple data (SIMD) circuits 308A-308B, the cache 307, and hardware resources (not shown). SIMD circuit 308A includes replicated circuitry of the circuitry of the SIMD circuit 308B. Although two SIMD circuits are shown, in other implementations, another number of SIMD circuits is used based on design requirements. As shown, the SIMD circuit 308B includes multiple, parallel computational lanes 306. Cache 307 can be used as a shared last-level cache in a compute circuit.

Memory 312 represents a local hierarchical cache memory subsystem. Memory 312 stores source data, intermediate results data, results data, and copies of data and instructions stored in memory devices 340. Processing circuit 310 is coupled to bus 325 via interface 309. Processing circuit 310 receives, via interface 309, copies of various data and instructions, such as the operating system 342, one or more device drivers, one or more applications such as application 346, and/or other data and instructions. The processing circuit 310 retrieves a copy of the application 346 from the memory devices 340, and the processing circuit 310 stores this copy as application 316 in memory 312. Similarly, processing circuit 310 retrieves a copy of at least a portion of operating system 342 and stores this copy as operating system 317 in memory 312.

In some implementations, the bus 325, or a fabric, includes circuitry for supporting communication, data transmission, network protocols, address formats, interface signals and synchronous/asynchronous clock domain usage for routing data. Memory controllers 330 are representative of any number and type of memory controllers accessible by processing circuits 302 and 310. While memory controllers 330 are shown as being separate from processing circuits 302 and 310, it should be understood that this merely represents one possible implementation. In other implementations, one of memory controllers 330 is embedded within one or more of processing circuits 302 and 310 or it is located on the same semiconductor die as one or more of processing circuits 302 and 310. Memory controllers 330 are coupled to any number and type of memory devices 340.

Memory devices 340 are representative of any number and type of memory devices. For example, the type of memory in memory devices 340 includes Dynamic Random Access Memory (DRAM), Static Random Access Memory (SRAM), NAND Flash memory, NOR flash memory, Ferroelectric Random Access Memory (FeRAM), or otherwise. Memory devices 340 store at least instructions of an operating system 342, one or more device drivers, and application 304. In some implementations, application 304 is a highly parallel data application such as a video graphics application, a shader application, or other. Copies of these instructions can be stored in a memory or cache device local to processing circuit 310 and/or processing circuit 302.

I/O interfaces 320 are representative of any number and type of I/O interfaces (e.g., peripheral component interconnect (PCI) bus, PCI-Extended (PCI-X), PCIE (PCI Express) bus, gigabit Ethernet (GBE) bus, universal serial bus (USB). Various types of peripheral devices (not shown) are coupled to I/O interfaces 320. Such peripheral devices include (but are not limited to) displays, keyboards, mice, printers, scanners, joysticks or other types of game controllers, media recording devices, external storage devices, and so forth. Network interface 335 receives and sends network messages across a network.

Computing system 300 includes an on-die electromagnetic monitor circuit 305 or sensor that measures electromagnetic interference (EMI) of the computing system 300. Computing system 300 also includes error reporting circuit 350, error log registers 352, sensors 354 and power managers 356. As shown, these components 350, 352, 354 and 356 have multiple replicated copies distributed across computing system 300. In various implementations, error reporting circuit 350 has the same functionality as error reporting circuit 110 (of FIG. 1) and apparatus 200 (of FIG. 2), error log registers 352 include data structures for storing parameters in a similar manner as error log registers 120, sensors 354 have the same functionality as sensors 130, and power managers 356 have the same functionality as power managers 140. Although the components 350, 352, 354 and 356 are shown in particular locations and as a single copy as sub-components within processing circuits and controllers, in other implementations more copies (instantiations) of the circuitry of components 350, 352, 354 and 356 are used and located among other sub-components such as at least cache 307, SIMD circuit 308A, a processor core (not shown) of processing circuit 310, and so on.

The multiple instantiations of components 350, 352, 354 and 356 monitor environmental conditions of multiple different locations across computing system 300. When an error occurs or a time interval has elapsed, parameters characterizing the environmental conditions are retrieved and stored. This information can be used later for error debugging, searching for a minimum power supply voltage, and other transient state data processing. In various implementations, at a later time, one or more of a processing circuit, diagnostic lab equipment, and so forth utilizes the history of information for error debugging, searching for a minimum supported power supply voltage, and other transient state data processing. Regarding searching for a minimum power supply voltage, the output voltage from a device (transistor) reduces as it drives a load. When driving a lot of current, even when utilizing a path with a low amount of resistance, the output voltage can experience voltage droop. Additionally, a simultaneous switching of a wide bus can cause a significant voltage drop if a supply pin served all of the line buffers on the bus. Parasitic inductance increases transmission line effects on an integrated circuit such as ringing and reduced propagation delays. The voltage regulator circuit needs to be designed to account for voltage droop. The recorded history of environmental conditions can improve the search for the minimum supported power supply voltage, the error debugging process, and other processing.

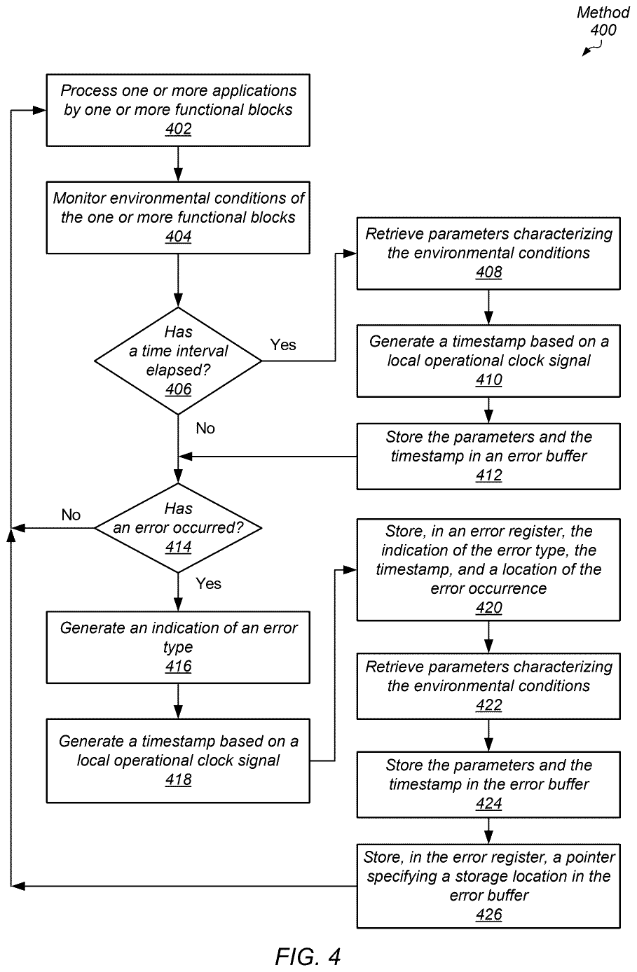

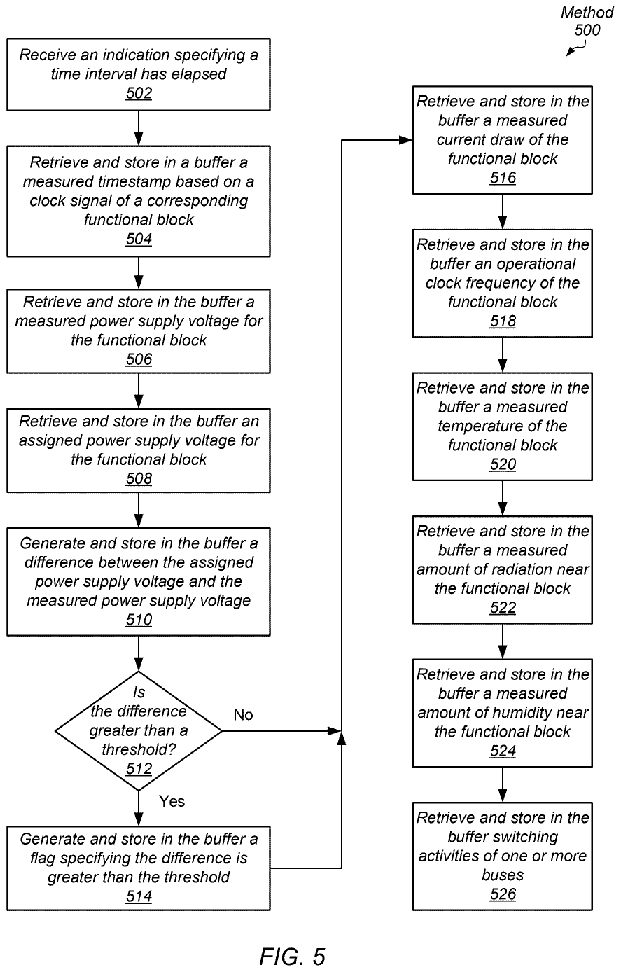

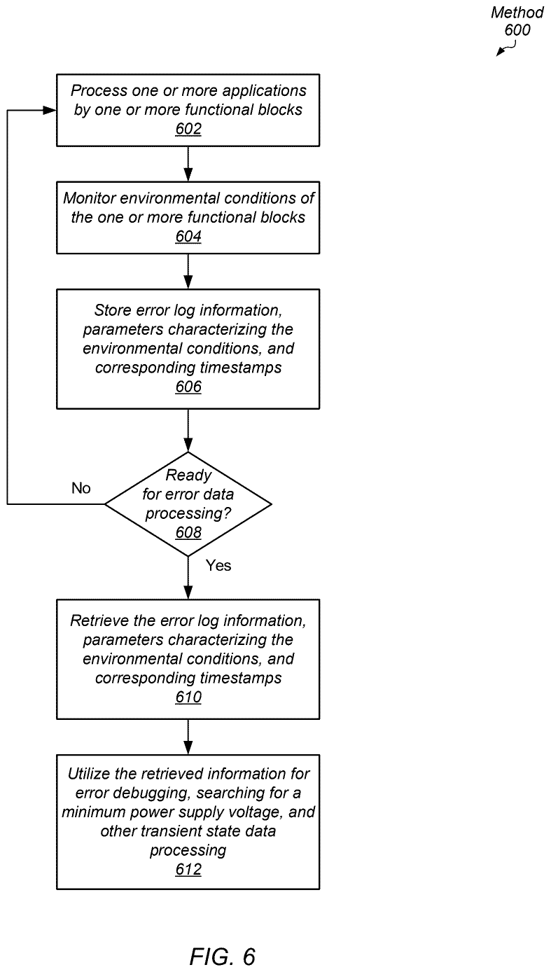

Referring to FIG. 4, a generalized diagram is shown of a method 400 for efficiently performing error reporting of an integrated circuit. For purposes of discussion, the steps in this implementation (as well as in FIGS. 5-6) are shown in sequential order. However, in other implementations some steps occur in a different order than shown, some steps are performed concurrently, some steps are combined with other steps, and some steps are absent.

One or more functional blocks process one or more applications (block 402). In various implementations, the one or more functional blocks are components of an integrated circuit such as a processing circuit, a processor core, a particular level of a cache memory hierarchy, a memory controller that interfaces with one or more memory devices, an input/output controller that interfaces with a peripheral device, a network interface, and so on. The components and sub-components of the computing system 300 are examples of one or more functional blocks. Similarly, functional blocks 150 and 160 (of FIG. 1) are examples of one or more functional blocks. Due to the variety of types of circuitry that can be included in functional blocks 150 and 160, functional blocks 150 and 160 can process a variety of types of tasks. The variety of types of tasks support the processing of instructions of algorithms implemented in applications, firmware and so on. These tasks can include a variety of types of computing operations such as arithmetic operations, memory access operations, data transmission operations, and so forth.

A combination of sensors, hardware performance counters, and control circuits monitor environmental conditions of the one or more functional blocks (block 404). In various implementations, the error reporting circuit 110, the error log registers 120, the sensors 130 and the power manager 140 (of FIG. 1) are examples of the circuits that monitor environmental conditions of one or more functional blocks. Similarly, the error reporting circuit 350, the error log registers 352, the sensors 354 and the power manager 356 (of FIG. 3) are examples of the circuits that monitor environmental conditions of one or more functional blocks. Examples of the environmental conditions are the operational power supply voltage, the operational clock frequency, the operational temperature, a measured amount of current draw by the one or more functional blocks, a measured amount of electromagnetic interference (EMI), a measured amount of ambient temperature, a measured amount of ambient humidity, a monitored switching activity of one or more buses, and so on.

If a time interval has not yet elapsed (“no” branch of the conditional block 406), and an error has not occurred (“no” branch of the conditional block 414), then control flow of method 400 returns to block 402 where one or more functional blocks process one or more applications. In some implementations, the time interval is a microsecond. However, in other implementations, another value is used for the time interval based on design requirements. If the time interval has elapsed (“yes” branch of the conditional block 406), then the error reporting circuit retrieves parameters characterizing the environmental conditions (block 408). Examples of these parameters are the examples of environmental conditions provided above.

The error reporting circuit generates a timestamp based on a local operational clock signal (block 410). Rather than using firmware or any other type of software to generate the timestamp, the error reporting circuit relies on the output clock signal of the hardware of the clock generating circuitry. In this manner, the point in time that the parameters characterizing environmental conditions are stored with respect to the elapsed time interval are related to the point in time these parameters are stored with respect to an error occurrence.

The error reporting circuit stores the parameters and the timestamp in an error buffer (block 412). In various implementations, the error buffer is a separate data structure from a data structure used to store error log information in control registers such as machine check architecture (MCA) registers. It is possible that the MCA registers do not have sufficient data storage space for the parameters. Each of the MCA registers and the error buffer can be accessed during a later debugging process. The one or more functional blocks perform error management based on the machine check architecture. The machine check architecture defines the steps and techniques used by the one or more functional blocks for detecting, reporting, and handling errors that occur in the computing system. Afterward, control of method 400 moves to conditional block 414 where it is determined whether an error has occurred.

If a time interval has not yet elapsed (“no” branch of the conditional block 406), and an error has occurred (“yes” branch of the conditional block 414), then the error reporting circuit generates an indication of an error type (block 416). Examples of the error types are translation lookaside buffer (TLB) errors, system bus errors, random access memory (RAM) storage errors, bit flipping errors, and so forth. The error reporting circuit generates a timestamp based on a local operational clock signal (block 418). Rather than using firmware or any other type of software to generate the timestamp, the error reporting circuit relies on the output clock signal of the hardware of the clock generating circuitry.

The error reporting circuit stores, in an error register such as a control register or MCA register, the indication of the error type, the timestamp, and a location of the error occurrence (block 420). The error reporting circuit retrieves parameters characterizing the environmental conditions (block 422). Examples of these parameters are the examples of environmental conditions provided above. The error reporting circuit stores the parameters and the timestamp in the error buffer (block 424). The error buffer is a separate data structure from a data structure used for the error register. Typically, the error buffer has more data storage capacity than the error register. The error reporting circuit stores, in the error register, a pointer specifying a storage location in the error buffer (block 426). The pointer is an address or other information (e.g., offset, mapping, other) identifying a data storage location. This storage location is the entry of the error buffer that has been allocated to store the recently retrieved parameters. Afterward, control flow of method 400 returns to block 402 where one or more functional blocks process one or more applications.

Turning now to FIG. 5, a generalized diagram is shown of a method 500 for efficiently performing error reporting of an integrated circuit. In various implementations, one or more functional blocks are components of an integrated circuit such as a processing circuit, a processor core, a particular level of a cache memory hierarchy, a memory controller that interfaces with one or more memory devices, an input/output controller that interfaces with a peripheral device, a network interface, and so on. The components and sub-components of the computing system 300 are examples of one or more functional blocks. Similarly, functional blocks 150 and 160 (of FIG. 1) are examples of the one or more functional blocks. An error reporting circuit receives an indication specifying a time interval has elapsed (block 502). The error reporting circuit is used with a variety of types of sensors and hardware performance counters to monitor environmental conditions of one or more functional blocks.

The error reporting circuit retrieves and stores in a buffer, such as an error buffer, a measured timestamp based on a clock signal of a corresponding functional block (block 504). In various implementations, the error buffer is a separate data structure from a data structure used to store error log information in control registers such as machine check architecture (MCA) registers. It is possible that the MCA registers do not have sufficient data storage space for the parameters. Each of the MCA registers and the error buffer can be accessed during a later debugging process. The error reporting circuit retrieves and stores in the buffer a measured power supply voltage for the functional block (block 506). For example, the error reporting circuit accesses or communicates with the power manager to obtain the currently used operational power supply voltage. The error reporting circuit retrieves and stores in the buffer an assigned power supply voltage for the functional block (block 508).

The error reporting circuit retrieves and stores in the buffer a difference between the assigned power supply voltage and the measured power supply voltage (block 510). If the difference is greater than a threshold (“yes” branch of the conditional block 512), then the error reporting circuit generates and stores in the buffer a flag specifying the difference is greater than the threshold (block 514). The error reporting circuit retrieves and stores in the buffer a measured current draw of the functional block (block 516). An on-die sensor or other circuitry, such as circuitry in the power manager or voltage regulator, can provide the measured amount of current draw. The error reporting circuit retrieves and stores in the buffer an operational clock frequency of the functional block (block 518). The error reporting circuit can access the power manager or clock generating circuitry to obtain this information.

The error reporting circuit retrieves and stores in the buffer a measured temperature of the functional block (block 520). An on-die sensor can provide this information. The error reporting circuit retrieves and stores in the buffer a measured amount of radiation near the functional block (block 522). An on-die electromagnetic monitor can provide information indicating a level of electromagnetic interference (EMI). The error reporting circuit retrieves and stores in the buffer a measured amount of humidity near the functional block (block 524). Off-die sensors that relate ambient temperature and humidity can provide ambient environment information surrounding the product using the functional block. The error reporting circuit retrieves and stores in the buffer switching activities of one or more buses of the functional block (block 526). The error reporting circuit can access hardware performance counters that monitor a ratio of data transmission lines of a bus that switch over time.

Referring to FIG. 6, a generalized diagram is shown of a method 600 for efficiently performing error reporting of an integrated circuit. One or more functional blocks process one or more applications (block 602). Circuitry monitors environmental conditions of the one or more functional blocks (block 604). The circuitry store error log information, parameters characterizing the environmental conditions, and corresponding timestamps (block 606). In various implementations, the one or more functional blocks are components of an integrated circuit such as a processing circuit, a processor core, a particular level of a cache memory hierarchy, a memory controller that interfaces with one or more memory devices, an input/output controller that interfaces with a peripheral device, a network interface, and so on. The components and sub-components of the computing systems 100 and 300 are examples of one or more functional blocks. Examples of the circuitry that monitors and stores the parameters characterizing the environmental conditions are the error reporting circuit 110, the error log registers 120, the sensors 130 and the power manager 140 (of FIG. 1) and the error reporting circuit 350, the error log registers 352, the sensors 354 and the power manager 356 (of FIG. 3).

If the processing of error data is not yet ready for processing (“no” branch of the conditional block 608), then control flow of method 600 returns to block 602 where one or more functional blocks process one or more applications. If the processing of error data is ready for processing (“yes” branch of the conditional block 608), then a processing circuit retrieves the error log information, parameters characterizing the environmental conditions, and corresponding timestamps (block 610). The processing circuit utilizes the retrieved information for error debugging, searching for a minimum power supply voltage, and other transient state data processing (block 612).

In various implementations, at a later time, one or more of a processing circuit, diagnostic lab equipment, and so forth utilizes the history of information for error debugging, searching for a minimum supported power supply voltage, and other transient state data processing. Regarding searching for a minimum power supply voltage, the output voltage from a device (transistor) reduces as it drives a load. When driving a lot of current, even when utilizing a path with a low amount of resistance, the output voltage can experience voltage droop. Additionally, a simultaneous switching of a wide bus can cause a significant voltage drop if a supply pin served all of the line buffers on the bus. Parasitic inductance increases transmission line effects on an integrated circuit such as ringing and reduced propagation delays. The voltage regulator circuit needs to be designed to account for voltage droop. The recorded history of environmental conditions can improve the search for the minimum supported power supply voltage, the error debugging process, and other processing.

It is noted that one or more of the above-described implementations include software. In such implementations, the program instructions that implement the methods and/or mechanisms are conveyed or stored on a computer readable medium. Numerous types of media which are configured to store program instructions are available and include hard disks, floppy disks, CD-ROM, DVD, flash memory, Programmable ROMs (PROM), random access memory (RAM), and various other forms of volatile or non-volatile storage. Generally speaking, a computer accessible storage medium includes any storage media accessible by a computer during use to provide instructions and/or data to the computer. For example, a computer accessible storage medium includes storage media such as magnetic or optical media, e.g., disk (fixed or removable), tape, CD-ROM, or DVD-ROM, CD-R, CD-RW, DVD-R, DVD-RW, or Blu-Ray. Storage media further includes volatile or non-volatile memory media such as RAM (e.g., synchronous dynamic RAM (SDRAM), double data rate (DDR, DDR2, DDR3, etc.) SDRAM, low-power DDR (LPDDR2, etc.) SDRAM, Rambus DRAM (RDRAM), static RAM (SRAM), etc.), ROM, Flash memory, non-volatile memory (e.g., Flash memory) accessible via a peripheral interface such as the Universal Serial Bus (USB) interface, etc. Storage media includes microelectromechanical systems (MEMS), as well as storage media accessible via a communication medium such as a network and/or a wireless link.

Additionally, in various implementations, program instructions include behavioral-level descriptions or register-transfer level (RTL) descriptions of the hardware functionality in a high-level programming language such as C, or a design language (HDL) such as Verilog, VHDL, or database format such as GDS II stream format (GDSII). In some cases, the description is read by a synthesis tool, which synthesizes the description to produce a netlist including a list of gates from a synthesis library. The netlist includes a set of gates, which also represent the functionality of the hardware including the system. The netlist is then placed and routed to produce a data set describing geometric shapes to be applied to masks. The masks are then used in various semiconductor fabrication steps to produce a semiconductor circuit or circuits corresponding to the system. Alternatively, the instructions on the computer accessible storage medium are the netlist (with or without the synthesis library) or the data set, as desired. Additionally, the instructions are utilized for purposes of emulation by a hardware-based type emulator from such vendors as Cadence®, EVE®, and Mentor Graphics®.

Although the implementations above have been described in considerable detail, numerous variations and modifications will become apparent to those skilled in the art once the above disclosure is fully appreciated. It is intended that the following claims be interpreted to embrace all such variations and modifications.

What is claimed is

1. An apparatus comprising:
data processing circuitry configured to process one or more tasks;
error reporting circuitry configured to:
responsive to an indication that an error has occurred in the data processing circuitry:
generate an indication of an error type corresponding to the error;
retrieve parameters characterizing environmental conditions of the data processing circuitry; and
store the error type and the parameters.

2. The apparatus as recited in claim 1, wherein the error reporting circuitry is configured to generate a first timestamp corresponding to the error based on a clock signal of the data processing circuitry.

3. The apparatus as recited in claim 2, wherein the error reporting circuitry is configured to:
store the error type with the first timestamp in an error architecture register; and
store the parameters with the first timestamp in a buffer.

4. The apparatus as recited in claim 3, wherein the error reporting circuitry is configured to store a pointer in the error architecture register indicating a data storage location in the buffer storing the parameters and the first timestamp.

5. The apparatus as recited in claim 2, wherein responsive to an indication that a time interval has elapsed, the error reporting circuitry is configured to:
generate a second timestamp based on a clock signal of the data processing circuitry;
retrieve parameters characterizing environmental conditions of the data processing circuitry; and
store the parameters with the second timestamp in a buffer.

6. The apparatus as recited in claim 1, wherein the parameters comprise one or more of an operational power supply voltage and an operational clock frequency.

7. The apparatus as recited in in claim 1, wherein the parameters comprise one or more of an amount of current draw of the data processing circuitry, a temperature of the data processing circuitry, and an amount of radiation emitted on the data processing circuitry.

8. A method, comprising:
processing one or more tasks by data processing circuitry of a functional block;
responsive to an indication that an error has occurred in the data processing circuitry:
generating, by error reporting circuitry of the functional block, an indication of an error type corresponding to the error;
retrieving, by the error reporting circuitry, parameters characterizing environmental conditions of the data processing circuitry; and
storing, by the error reporting circuitry, the error type and the parameters.

9. The method as recited in claim 8, wherein the error reporting circuitry is configured to generate a first timestamp corresponding to the error based on a clock signal of the data processing circuitry.

10. The method as recited in claim 9, further comprising:
storing, by the error reporting circuitry, the error type with the first timestamp in an error architecture register; and
storing, by the error reporting circuitry, the parameters with the first timestamp in a buffer.

11. The method as recited in claim 10, further comprising storing, by the error reporting circuitry, a pointer in the error architecture register indicating a data storage location in the buffer storing the parameters and the first timestamp.

12. The method as recited in claim 9, wherein responsive to an indication that a time interval has elapsed, the method further comprises:
generating, by the error reporting circuitry, a second timestamp based on a clock signal of the data processing circuitry;
retrieving, by the error reporting circuitry, parameters characterizing environmental conditions of the data processing circuitry; and
storing, by the error reporting circuitry, the parameters with the second timestamp in a buffer.

13. The method as recited in claim 8, wherein the parameters comprise one or more of an operational power supply voltage and an operational clock frequency.

14. The method as recited in claim 13, wherein the parameters comprise one or more of an amount of current draw of the data processing circuitry, a temperature of the data processing circuitry, and an amount of radiation emitted on the data processing circuitry.

15. A computing system comprising:
a memory; and
a plurality of functional blocks, each comprising:
data processing circuitry configured to process one or more tasks stored in the memory;
error reporting circuitry configured to:
responsive to an indication that an error has occurred in the data processing circuitry:
generate an indication of an error type corresponding to the error;
retrieve parameters characterizing environmental conditions of the data processing circuitry; and
store the error type and the parameters.

16. The computing system as recited in claim 15, wherein the error reporting circuitry is configured to generate a first timestamp corresponding to the error based on a clock signal of the data processing circuitry.

17. The computing system as recited in claim 16, wherein the error reporting circuitry is configured to:
store the error type with the first timestamp in an error architecture register; and
store the parameters with the first timestamp in a buffer.

18. The computing system as recited in claim 17, wherein the error reporting circuitry is configured to store a pointer in the error architecture register indicating a data storage location in the buffer storing the parameters and the first timestamp.

19. The computing system as recited in claim 16, wherein responsive to an indication that a time interval has elapsed, the error reporting circuitry is configured to:
generate a second timestamp based on a clock signal of the data processing circuitry;
retrieve parameters characterizing environmental conditions of the data processing circuitry; and
store the parameters with the second timestamp in a buffer.

20. The computing system as recited in claim 15, wherein the parameters comprise one or more of an amount of current draw of the data processing circuitry, a temperature of the data processing circuitry, and an amount of radiation emitted on the data processing circuitry.
